(19) United States
(12) Patent Application Publication
(10) Pub. No.: US 2026/0307598 A1
(43) Pub. Date: Oct. 8, 2026

(54) DECORATIVE VEHICLE GRILLE ACCESSORY WITH FLEXIBLE ATTACHMENT

(71) Applicant: Denise Hahn, Moreland Hills, OH (US)

(72) Inventor: Denise Hahn, Moreland Hills, OH (US)

(21) Appl. No.: 19/237,265

(22) Filed: Jun. 13, 2025

Related U.S. Application Data
(60) Provisional application No. 63/783,324, filed on Apr. 4, 2025.

(51) Int. Cl. B60R 13/04; B60R 19/52

(52) U.S. Cl. CPC B60R 13/04; B60R 19/52

(57) ABSTRACT

The present disclosure provides a vehicle accessory comprising a decorative portion having a flat back and a front face, the decorative portion having a length, a height, a width and a stem connected to the flat back of the decorative portion. The stem having a length and comprising a plurality of flexible fins decreasing in diameter from a base of the stem to a tip of the stem, wherein the vehicle accessory is configured to be inserted into and retained within openings of a vehicle grille. The stem may be made of a flexible, corrugated material such as ABS or silicone and connected to the decorative portion using an adhesive.

### CROSS REFERENCE TO RELATED APPLICATIONS

This application claims the benefit of U.S. Provisional Patent Application No. 63/783,324 filed on Apr. 4, 2025, which is incorporated by reference herein in its entirety

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present disclosure relates in general to the field of vehicle accessories, and more particularly, to a decorative accessory designed for insertion into vehicle grilles to enhance visual appeal and personalization

### 2) Description of related art

Currently the state of the art includes numerous customization and personalization devices design to personalize a vehicle such as a car or truck. These include decals, custom components such as mirrors and trailer hitch accessories.

Vehicle customization and personalization have become increasingly popular among car enthusiasts and everyday drivers alike. Many individuals seek ways to express their personality and style through their vehicles, going beyond the standard factory options. This desire for customization extends to various aspects of a vehicle, including its exterior appearance.

One area of particular interest for vehicle personalization is the front grille. The grille serves both functional and aesthetic purposes, acting as an air intake for the engine while also contributing significantly to the vehicle's overall look. As such, it presents an opportunity for drivers to add a unique touch to their cars.

Traditionally, customizing a vehicle's grille often involved replacing the entire component or adding aftermarket inserts. These modifications can be costly, time-consuming, and may require professional installation. Additionally, such changes might be permanent or difficult to reverse, limiting the flexibility for drivers who wish to update their vehicle's appearance periodically.

There is a growing market for accessories that allow for easier and more accessible vehicle customization. Ideally, these accessories would be simple to install and remove, allowing users to change their vehicle's appearance without the need for specialized tools or expertise. Such products could appeal to a wide range of consumers, from car enthusiasts to those simply looking for a way to make their vehicle stand out.

Therefore, there is a need for a simple and cost-effective way to provide a accessories that are simple to install and remove from a person's vehicle.

These and other objects, features, and advantages of the present invention will become more readily apparent from the attached drawings and the detailed description of the preferred embodiments, which follow.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

As the automotive industry continues to evolve, there is an ongoing need for innovative solutions that allow vehicle owners to personalize their cars in simple, cost-effective ways. Accessories that can enhance a vehicle's appearance without requiring permanent modifications or specialized installation could fill a gap in the current market for automotive customization products. The vehicle grille is an ideal location for displaying accessories to customize a vehicle look or owners'affiliation such as football or college team support.

However, designing accessories for vehicle grilles presents several challenges. The accessory must be secure enough to withstand various driving conditions while also being easy to install and remove. It should be compatible with a wide range of vehicle models and grille designs. Additionally, the accessory must not interfere with the grille's primary function of allowing airflow to the engine.

According to an aspect of the present disclosure, a vehicle accessory is provided. The vehicle accessory includes a decorative portion and a stem. The decorative portion is flat-backed and front-facing, with a width dimensions generally between 5 cm to 15 cm in length, 5 cm to 15 cm in height, and 0.5 cm in thickness. The stem is connected directly to the decorative portion with adhesive or other attachment technology such as a screw thread or pin and has a length generally between 2 to 6 inches. The stem includes a plurality of flexible fins. The preferred number of flexible fins is 6 decreasing in diameter from 2-3 inches down to 0.25 inch.

According to other aspects of the present disclosure, the vehicle accessory may include one or more of the following features. The decorative portion may be made of Acrylonitrile Butadiene Styrene (ABS), Polyvinyl Chloride (PVC), silicone, thermoplastic, nylon, Low-Density Polyethylene (LDPE) or other similar flexible material. The stem may be made of flexible, corrugated ABS, silicone, thermoplastic, nylon, Low-Density Polyethylene (LDPE) or similar flexible material. The vehicle accessory may be designed to be inserted into a vehicle's grille with minimal effort, maintaining stability when inserted. The flexible fins of the stem may fold towards the front of the vehicle as the accessory is being inserted into the grille. The vehicle accessory needs to be easily moved, removed, and replaced to update or add to the vehicle's identity and style.

According to another aspect of the present disclosure, a method of manufacturing the vehicle accessory is provided. The method includes designing the decorative portion using CAD or CAM software to ensure the result is precise, manufacturable, and visually appealing. The vehicle accessory may be made by an injection molding process or by 3-D printing or Stereolithography (SLA) 3D printing technology.

According to other aspects of the present disclosure, the vehicle accessory may be used for branding, team or college association, personal expression, and advertising for the front of the vehicle. The vehicle accessory may enhance the visual appeal of a vehicle and contribute to the vehicle's identity and style.

The foregoing general description of the illustrative embodiments and the following detailed description thereof are merely exemplary aspects of the teachings of this disclosure and are not restrictive.

Bearing in mind the problems and deficiencies of the prior art, it is therefore an object of the present invention to provide a vehicle accessory that includes a decorative portion and a stem for attachment to a vehicle grille.

Still other objects and advantages of the invention will in part be obvious and will in part be apparent from the specification.

The above and other objects, which will be apparent to those skilled in the art, are achieved in the present invention, which is directed to a vehicle accessory, comprising:
a. a decorative portion having a flat back and a front face, the decorative portion having a width between 5 cm and 15 cm, a height between 5 cm and 15 cm, and a thickness of about 0.5 cm; and
b. a stem connected to the flat back of the decorative portion, the stem having a length between 2 inches and 4 inches and comprising a plurality of flexible fins decreasing in diameter from a base of the stem to a tip of the stem; and
c. wherein the vehicle accessory is configured to be inserted into and retained within openings of a vehicle grille.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1A illustrates a front-facing decorative portions of the instant innovation, according to aspects of the present disclosure.

FIG. 1 B illustrates an alternative front-facing decorative portions of the instant innovation, according to aspects of the present disclosure.

FIG. 2 depicts a side view of a stem component of the instant innovation, according to aspects of the present disclosure.

FIG. 3 shows a perspective view of a corrugated stem component of the instant innovation, according to aspects of the present disclosure.

FIG. 4 illustrates a front orthogonal view of a vehicle grille with an embodiment of the instant innovation installed, according to aspects of the present disclosure.

FIG. 5 shows a top view of a corrugated stem component of the instant innovation, according to aspects of the present disclosure.

FIG. 6 shows a front orthogonal view of an alternative embodiment of the instant innovation.

FIG. 7 shows a kit of the components of the instant innovation.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms accessory and accessories are used interchangeably to mean at least one embodiment of at least one component of the instant innovation.

The term vehicle as used in this disclosure can mean any device that his used as transportation including but not limited to automobiles, motorcycles, trucks, recreational vehicles. trailers and other transportation devices.

Prior to a discussion of the preferred embodiment of the invention, it should be understood that while the features and advantages of the invention are illustrated in terms of an accessory the invention can be used as an accessory to many different machines or structures.

The present disclosure relates to a vehicle accessory designed to enhance the visual appeal and personalization of vehicles. The instant innovation comprises decorative elements that can be easily inserted into most standard front-facing grilles, providing embodiments for vehicle owners to customize the appearance of vehicles. These accessories offer a versatile platform for branding, personal expression, and advertising on the front or rear of a vehicle.

The instant innovation comprises a front-facing decorative portion attached to a flexible stem component, allowing for secure placement within the grille structure of various vehicle models. The design of embodiments of the instant innovation enables easy installation and removal, facilitating updates or changes to the vehicle's identity and style as desired by the owner.

The decorative portion of the instant innovation may feature a wide range of designs, patterns, or logos, accommodating diverse preferences and purposes. This versatility allows vehicle owners to showcase individuality, promote businesses, or display affiliations through a vehicle's appearance.

The attachment mechanism of embodiments of the instant innovation is engineered to provide a secure fit within the grille while minimizing the risk of damage to the vehicle. The flexible nature of the stem component allows for adaptation to different grille configurations, ensuring compatibility with a broad range of vehicle make and model.

In some cases, the instant innovation may be constructed using durable materials that withstand various weather conditions and regular vehicle use. This construction aims to maintain the aesthetic appeal of the accessory over time, providing a lasting customization option for vehicle owners.

The following detailed description will elaborate on the components, construction, and operation of the instant innovation, providing a comprehensive understanding of this vehicle accessory and its applications.

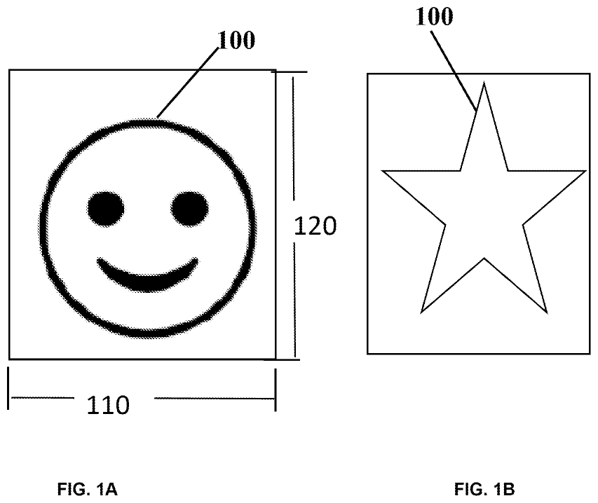

The decorative portion of embodiments of the instant innovation may be designed to enhance the visual appeal of a vehicle's grille. As shown in FIG. 1A and FIG. 1B, the decorative portion 100 may feature various designs, patterns, or logos to accommodate diverse preferences and purposes. In some cases, the decorative portion may include simple or complex shapes, comprising any variation or combination of geometric shapes, fractals, Archimedean solids, Soft Cells, circles, squares, smiley faces, flower patterns, and any other desired shapes, some which are illustrated in FIG. 1A and FIG. 1B.

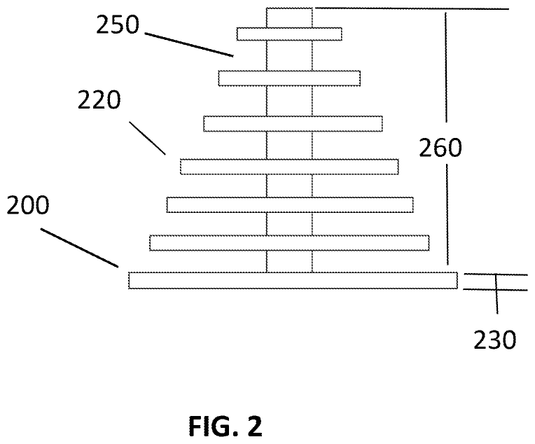

The dimensions of the decorative portion may vary to suit different vehicle grille configurations and aesthetic preferences. In some cases, the decorative portion may range in size as shown in FIG. 1 from a height 120 of 5 cm to 15 cm in and from a length 110 of between 5 cm to 15 cm. The thickness of the decorative portion 100 as shown in FIG. 2 a thickness 230 may be about 0.5 cm, providing a low-profile appearance when installed on the vehicle grille.

Embodiments of the instant innovation may be constructed using various materials to ensure durability and flexibility. In some cases, the decorative portion may be made of Acrylonitrile Butadiene Styrene (ABS), thermoplastic, nylon, Low-Density Polyethylene (LDPE), Polyvinyl Chloride (PVC) or any other suitable material. These materials offer a balance of strength and flexibility, allowing embodiments of the instant innovation to withstand various weather conditions and regular vehicle use. In other cases, silicone or other similar flexible materials may be used for the construction of the decorative portion, providing additional adaptability to different grille configurations.

The decorative portion may be manufactured using well-known molding techniques, in some instances, injection molding. This manufacturing process allows for precise replication of intricate designs and patterns on the front-facing surface of embodiments the instant innovation. In some cases, Computer-Aided Design (CAD) or Computer-Aided Manufacturing (CAM) software may be utilized to create and refine the decorative designs, ensuring that the resulting product is visually appealing and manufacturable.

Additionally, the instant innovation can be made using 3-D printing or Stereolithography (SLA) 3D printing technology which will allow for lower cost and more flexible manufacturing processes.

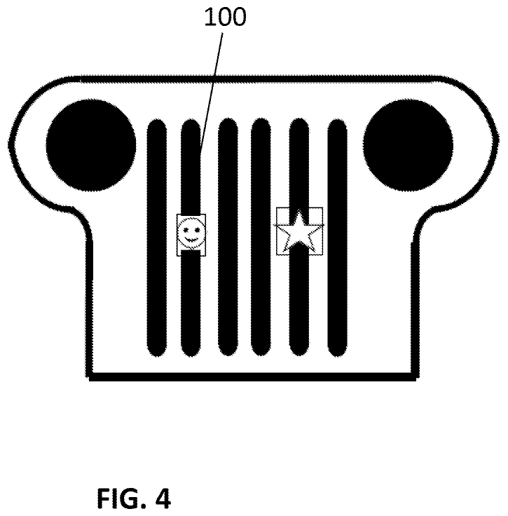

As illustrated in FIG. 4, the decorative portion 100 of embodiments of the instant innovation may be easily inserted into the openings of a vehicle's front or rear grille. The figure shows two embodiments of the instant innovation installed on a vehicle, demonstrating how these decorative elements can be integrated into existing grille structures without requiring modifications to the vehicle.

The decorative portion may serve various purposes beyond mere aesthetics. In some cases, embodiments of the instant innovation may be used for branding, allowing businesses to display logos or slogans on vehicles. In other cases, the decorative portion may be used for personal expression, enabling vehicle owners to showcase individuality or interests. Additionally, the decorative portion may be utilized for advertising purposes, providing a unique platform for promotional content on the front or rear of a vehicle.

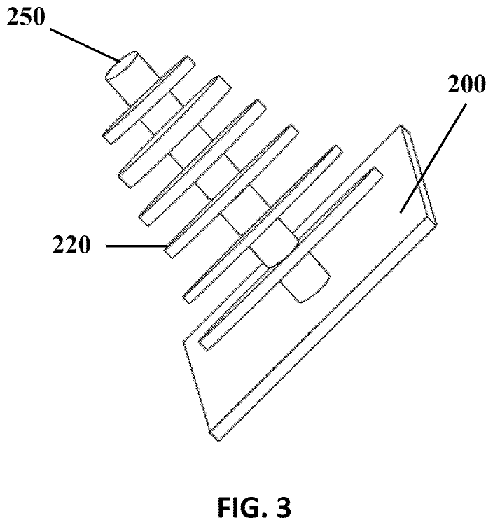

The stem component 250 of embodiments of the instant innovation serves as an attachment mechanism that secures the decorative portion 100 on support 200 to a vehicle's front or rear grille. As illustrated in FIG. 2 and FIG. 3, the stem component 250 a features a unique design that enables secure placement within various grille configurations.

In some cases, as shown in FIG. 2 the stem component may range in length 260 between 2 to 6 inches. This length allows for sufficient insertion into the grille while maintaining stability of the decorative portion. The stem component may be constructed using flexible, corrugated materials, in some instances, Acrylonitrile Butadiene Styrene (ABS), thermoplastic, silicone, nylon, Low-Density Polyethylene (LDPE) or similar flexible materials. The use of these materials provides the necessary flexibility for insertion and removal while ensuring durability during regular vehicle use.

A notable feature of the embodiment of the stem component 250 as shown in FIG. 2, is the presence of six flexible fins 220, respectively. These fins 220 decrease in diameter from the base to the tip of the stem component 250. In some cases, the largest fin near the base may have a diameter between 2 to 5 inches, while the smallest fin at the tip may have a diameter of about 0.25 inches. This tapered design allows for easy insertion into a grille while providing secure retention once installed. The number and size of the flexible fins 220 is customizable and depends on the grille structure the instant innovation is targeted to be used on. Therefore, a plurality of flexible fins 220 is needed.

The flexible nature of the fins enables them to compress during insertion and expand once in place, creating a snug fit within grille openings. This design feature contributes to the stability of embodiments of the instant innovation when installed on the vehicle, as shown in FIG. 4.

In some cases, embodiments of the stem component may be connected to the decorative portion using an adhesive. This connection method ensures a strong bond between the two components while maintaining the overall flexibility of embodiments of the instant innovation. The use of adhesive allows for a seamless transition between embodiments of the decorative portion and the stem component, enhancing both the aesthetic appeal and functional integrity of the accessory. The adhesive may be applied in numerous ways, including brushing it on with a paintbrush or bristle brush for even coverage, spraying it using an aerosol can or spray gun for fine mists or large surfaces, rolling it on with a foam or lint-free roller for smooth and consistent application, dabbing it with a sponge or foam pad for controlled and localized placement, extruding it through a caulk gun or syringe for precise bead or line application, dipping components into a liquid adhesive bath for full submersion coating, using a hot glue gun for rapid-setting thermoplastic adhesives, applying it with a notched trowel for thick and textured layers often used in tiling, spreading it with a putty knife or spatula for small repairs or gap filling, utilizing double-sided adhesive tapes or films for clean and instant bonding, employing pressure-sensitive adhesive sheets or labels for quick stick-on applications, dispensing it via automated robotic systems for high-precision industrial use, or using a dropper or pipette for minute and accurate liquid adhesive placement.

Alternatively, the stem component 250 could have a connection to accept a thread, a pin or other latching mechanism to secure the stem component 250 to the vehicle.

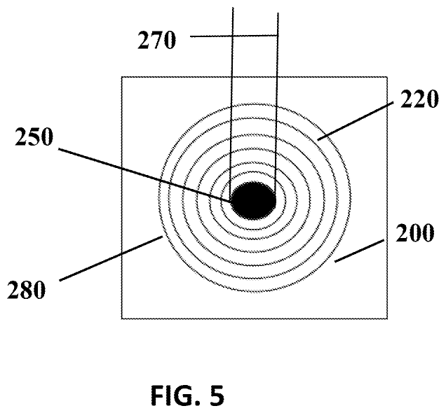

The corrugated structure of the stem component 250, as depicted in FIG. 3, provides additional flexibility and compressibility. This design feature allows the stem component 250 to adapt to various grille configurations and thicknesses, enhancing the universal applicability of embodiments of the instant innovation across different vehicle models. While the design shown in FIG. 3 and FIG. 5 shows a round flexible fin 220 the flexible fin 220 could be selected from a number of shapes including round, square, rectangle, star shape or other polygon shaped flexible fin.

The attachment mechanism of embodiments of the instant innovation needs to provide a secure and versatile measure of affixing the decorative elements to various vehicle grilles without causing damage. As illustrated in FIG. 2 and FIG. 3, embodiments of the stem component 250 and flexible fins 220 of the instant innovation feature a unique design that enables secure placement within different grille configurations.

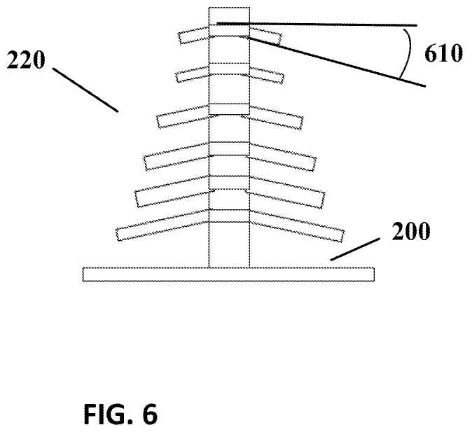

In some cases, the flexible fins 220 as shown in FIG. 6 may be installed at an angle 610 with respect to the surface projection of support 200. The angle 610 can be from 1-50 degrees but preferably 15 degrees.

In some cases, the stem component may comprise a series of flexible fins 220 arranged in a tapered configuration. These fins may decrease in diameter from one end to the other, creating a corrugated structure that allows for flexibility and compression when inserted into a vehicle grille. The flexible nature of the fins may enable them to compress during insertion and expand once in place, creating a snug fit within grille openings.

The material composition of the stem component may contribute to its adaptability and ease of use. In some cases, the stem component may be constructed using flexible materials, in some instances, Acrylonitrile Butadiene Styrene (ABS), silicone, thermoplastic, nylon, Low-Density Polyethylene (LDPE) or similar flexible materials. This choice of materials may provide the necessary flexibility for insertion and removal while ensuring durability during regular vehicle use.

The universal design of the attachment mechanism allows embodiments of the instant innovation to be compatible with a wide range of vehicle models. As shown in FIG. 4, embodiments of the instant innovation may be easily inserted into the openings of a vehicle's front or rear grille. The figure demonstrates how these decorative elements can be integrated into existing grille structures without requiring modifications to the vehicle.

In some cases, the installation process of embodiments of the instant innovation may be straightforward and user-friendly. The stem component may be inserted into any chosen section of a vehicle's grille by a simple hand push. The flexible fins may fold towards the front or rear of the vehicle as the stem component is being inserted, facilitating easy placement.

The removal process of embodiments of the instant innovation is equally simple. Due to the flexibility of the base of embodiments of the stem component, embodiments of the instant innovation may be easily moved, removed, and replaced. This feature may allow vehicle owners to update or add to the identity and style of a vehicle as desired.

The attachment mechanism may be designed to provide stability once installed. The tapered design of the stem component, with fins decreasing in diameter, may contribute to the secure placement of embodiments of the instant innovation within the grille structure. This design may help prevent unwanted removal while still allowing for intentional repositioning or replacement.

In some cases, the attachment mechanism needs to be engineered to minimize the risk of damage to the vehicle's grille. The flexible nature of the stem component and fins allows embodiments of the instant innovation to adapt to different grille configurations without exerting excessive pressure on the grille structure. This design consideration helps preserve the integrity of the vehicle's grille while providing a secure attachment for the decorative elements.

The material composition of the instant innovation contributes to the durability, flexibility, and resistance of embodiments of the instant innovation to various weather conditions. In some cases, the decorative portion of embodiments of the instant innovation may be constructed using thermoplastic, nylon, Low-Density Polyethylene (LDPE), silicone, Acrylonitrile Butadiene Styrene (ABS) or Polyvinyl Chloride (PVC). These materials offer a combination of strength and flexibility, allowing the accessory to withstand regular use and exposure to different environmental factors.

In some cases, the stem component of embodiments of the instant innovation may be made from flexible, corrugated materials, in some instances, ABS, silicone, nylon, Low-Density Polyethylene (LDPE), thermoplastic or similar flexible substances. As shown in FIG. 2and FIG. 3, an embodiment of the stem component 250 features a series of flexible fins that may compress and expand during installation and use. The choice of flexible materials for the stem component may allow for easy insertion into various grille configurations while maintaining a secure fit.

The material composition may contribute to the longevity of embodiments of the instant innovation. In some cases, the materials used may resist degradation from exposure to sunlight, rain, and temperature fluctuations. This resistance to weathering may help maintain the aesthetic appeal of the accessory over time, as illustrated in FIG. 4, where embodiments of the instant innovation are shown installed on a vehicle's front grille.

The flexibility of the chosen materials may also enhance the versatility of embodiments of the instant innovation. As depicted in FIG. 4, FIG. 1A and FIG. 1 B, the decorative portion 100 may feature various designs and patterns. The use of flexible materials may allow for intricate designs to be molded and maintained, contributing to the overall aesthetic appeal of the accessory. Alternatively, the decorative portion 100 could be a sticker or placard that is attached to the exposed face of support 200 using adhesive, screws, rivets or other suitable attachment mechanism. Also, the shape of support 200 could be selected from a number of shapes including round, square, rectangle, star shape or other polygon shaped to form support 200.

In some cases, the material composition may provide a balance between rigidity and flexibility. This balance allows embodiments of the instant innovation to maintain at least one shape when installed, as shown in FIG. 4, while also allowing for easy removal and repositioning without causing damage to the vehicle's grille.

The choice of materials for embodiments of the instant innovation also comprises factors, in some instances, establishing color retention and resistance to fading. In some cases, the materials used may be capable of maintaining vibrant colors and clear designs even after prolonged exposure to outdoor conditions. This characteristic may contribute to the long-term visual appeal of the accessory.

The material composition of embodiments of the instant innovation may also take into account the potential for impact resistance. In some cases, the chosen materials may be able to withstand minor impacts from road debris without cracking or breaking, further contributing to the longevity of the accessory.

The installation process of embodiments of the instant innovation may be straightforward and user-friendly. As shown in FIG. 4, embodiments of the instant innovation may be inserted into any chosen section of a vehicle's grille by a simple hand push. The flexible stem component 250 illustrated in FIG. 2 and FIG. 3, respectively, may allow for easy insertion into various grille configurations.

During insertion, the flexible fins on embodiments of the stem component are enabled to fold towards the front or rear of the vehicle. This folding action, facilitated by the corrugated structure of the stem component 250 depicted in FIG. 3, may enable smooth placement of embodiments of the instant innovation within grille openings. The tapered design of the stem component, with fins decreasing in diameter from base to tip, may contribute to the ease of insertion.

Once inserted, the flexible fins may expand within the grille structure, providing a secure fit. This expansion may help maintain the stability of embodiments of the instant innovation once installed, as demonstrated in FIG. 4. The combination of the flexible material and the fin design may allow embodiments of the instant innovation to adapt to different grille thicknesses and configurations while remaining firmly in place.

Removal of embodiments of the instant innovation is equally simple. The flexibility of embodiments of the stem component 250 and 250, as shown in FIG. 2 and FIG. 3, may allow for easy extraction from the grille. Users may gently pull on the decorative portion 100, shown in FIG. 1A and FIG. 1B, to remove embodiments of the instant innovation from the grille structure. The flexible fins may compress during removal, facilitating a smooth extraction process without causing damage to the vehicle's grille.

In some cases, embodiments of the instant innovation may be easily moved or repositioned within the grille structure. The flexibility of the stem component allows users to adjust the position of the embodiments of the instant innovation without fully removing them from the grille. This feature enables users to fine-tune the placement of the decorative elements for optimal visual appeal.

The ability to easily move, remove, and replace embodiments of the instant innovation can provide users with the flexibility to update or add to the identity and style of vehicles. In certain embodiments of the present disclosure, the decorative elements can be changed to reflect different seasons, events, or personal preferences. This versatility may allow vehicle owners to customize the appearance of vehicles without the need for permanent modifications to the grille structure.

The manufacturing process for embodiments of the instant innovation can involve several steps to ensure precision and visual appeal of the final product. In some cases, injection molding may be utilized as the primary manufacturing technique for producing embodiments of the instant innovation.

Injection molding can offer several advantages for the production of embodiments of the instant innovation. This process may allow for the creation of complex shapes and intricate details, which may be particularly beneficial for the decorative portion 100 of embodiments of the instant innovation, as illustrated in FIG. 1A and FIG. 1B. The injection molding process may also provide consistency in production, ensuring that each embodiment of the instant innovation meets specified dimensions and quality standards.

In some cases, the design process for the decorative portion of embodiments of the instant innovation may involve the use of Computer-Aided Design (CAD) or Computer-Aided Manufacturing (CAM) software. These software tools may enable designers to create precise, three-dimensional models of the decorative elements. The use of CAD or CAM software may allow for the exploration of various design options and the refinement of details before the actual manufacturing process begins. Alternatively, the instant innovation could be made using 3-D printing or Stereolithography (SLA) 3D printing technology.

The CAD or CAM software may be used to design both the embodiments of the decorative portion 100, as shown in FIG. 1 and FIG. 1B, and embodiments of the stem component 250 with its flexible fins, as depicted in FIGS. 2 and 3, respectively. This digital design process may help ensure that embodiments of the decorative elements are not only visually appealing but also manufacturable and compatible with the attachment mechanism.

Once the design is finalized using CAD or CAM software, the digital model may be used to create molds for the injection molding process. These molds may be precision-engineered to capture all the details of the design, including the intricate patterns on embodiments of the decorative portion and embodiments of the structure of the stem component.

During the injection molding process, the chosen material, in some instances can include but not limited to nylon, Low-Density Polyethylene (LDPE), silicone, thermoplastic, Acrylonitrile Butadiene Styrene (ABS) or Polyvinyl Chloride (PVC), may be heated until the material reaches a molten state. The molten material may then be injected into the mold under high pressure. As the material cools and solidifies, the material takes on the shape of the mold, creating embodiments of various structures of the instant innovation, comprising at least embodiments of decorative components and attachment components.

In some cases, the manufacturing process can involve multiple injection molding steps. Certain embodiments of the decorative portion and the stem component may be molded separately and then joined together using adhesive. This multi-step process may allow for the use of different materials or colors for various components of embodiments of the instant innovation. The adhesive may be applied in numerous ways, including brushing it on with a paintbrush or bristle brush for even coverage, spraying it using an aerosol can or spray gun for fine mists or large surfaces, rolling it on with a foam or lint-free roller for smooth and consistent application, dabbing it with a sponge or foam pad for controlled and localized placement, extruding it through a caulk gun or syringe for precise bead or line application, dipping components into a liquid adhesive bath for full submersion coating, using a hot glue gun for rapid-setting thermoplastic adhesives, applying it with a notched trowel for thick and textured layers often used in tiling, spreading it with a putty knife or spatula for small repairs or gap filling, utilizing double-sided adhesive tapes or films for clean and instant bonding, employing pressure-sensitive adhesive sheets or labels for quick stick-on applications, dispensing it via automated robotic systems for high-precision industrial use, or using a dropper or pipette for minute and accurate liquid adhesive placement.

The combination of CAD or CAM design and injection molding may result in embodiments of the instant innovation that are precise, visually appealing, and suitable for installation in vehicle grilles, as demonstrated in FIG. 4. This manufacturing approach may enable the production of embodiments of the instant innovation with consistent quality and the ability to replicate intricate designs across multiple units. Alternatively, the instant innovation could be made using 3-D printing or Stereolithography (SLA) 3D printing technology.

In some cases, embodiments of the instant innovation may be designed with various sizes and shapes to accommodate different vehicle grille configurations and personal preferences. The decorative portion 100, as illustrated in FIG. 1 and FIG. 1B, may be produced in a range of dimensions that are larger or smaller than the previously mentioned 5 cm to 15 cm length and height. Certain smaller embodiments of the instant innovation may be created for compact vehicles with narrower grille openings, while larger versions may be designed for trucks or SUVs with more expansive grille openings.

The shape of the decorative portion 100 may also vary from the circular designs shown in FIG. 1 and FIG. 1B to square, rectangle, pentagon, triangle, octagonal or any suitable shape. In some cases, embodiments of the instant innovation may feature square, rectangular, triangular, or custom-shaped decorative elements to suit different aesthetic preferences or branding requirements. These variations in shape may allow for more diverse design options and personalization opportunities.

The material composition of embodiments of the instant innovation may be expanded beyond ABS, PVC, nylon, Low-Density Polyethylene (LDPE), thermoplastics, and silicone. In some cases, alternative materials comprising durable plastics, composite materials, or even lightweight metals may be used for specific applications. Certain high-end luxury vehicles may utilize embodiments of the instant innovation made from premium materials to enhance the overall aesthetic appeal.

Embodiments of the stem component 250 as depicted in FIGS. 2 and 3, respectively, may also be subject to variations. In some cases, the number of flexible fins may be increased or decreased to accommodate different grille thicknesses or to provide varying levels of retention force. The length and diameter of the stem component may be adjusted to suit specific vehicle models or grille designs.

Embodiments of the instant innovation may alternatively be used with vehicles that are not personal vehicle customization. In some cases, fleet vehicles for businesses may utilize embodiments of the instant innovation as a branding tool. Certain embodiments may be used by a delivery company to feature a logo across an entire fleet, creating a consistent and recognizable brand image on the road.

The advertising potential of embodiments of the instant innovation may be explored further. In some cases, interchangeable embodiments of the instant innovation may be developed to allow for temporary promotional campaigns. For instance, a sports team may offer limited-edition embodiments of the instant innovation to fans during playoff seasons, allowing supporters to showcase team spirit on vehicles.

Personal expression through embodiments of the instant innovation may extend to various themes and interests. As shown in FIG. 4, embodiments of the instant innovation may feature simple designs like smiley faces or flowers. In some cases, more complex designs representing hobbies, professions, or cultural symbols may be created to allow vehicle owners to express individuality.

The application of embodiments of the instant innovation may extend to special events or occasions. In some cases, seasonal embodiments of the instant innovation may be designed for holidays or festivals, allowing vehicle owners to temporarily decorate vehicles in a festive manner. Certain embodiments may be heart-shaped and may be popular around Valentine's Day, while certain embodiments of snowflake designs may be favored during winter months.

In some cases, embodiments of the instant innovation may be designed with additional functionalities beyond decoration. For instance, embodiments of the instant innovation may incorporate reflective materials to enhance visibility at night, or may be engineered with small LED lights and a self-contained battery. Alternatively, the LED could be connected to the vehicle power system to power the LED. Adding the ability to provide light from an LED to create illuminated designs on the vehicle's grille can provide the ability to effectively display the accessory at night..

The manufacturing process for embodiments of the instant innovation may be adapted to allow for customization. In some cases, 3D printing or Stereolithography (SLA) 3D printing technology may be utilized to produce small batches of personalized embodiments of the instant innovation, enabling customers to create unique designs or incorporate personal logos into vehicle accessories.

The attachment mechanism of embodiments of the instant innovation, as illustrated in FIGS. 2 and 3, may be modified for specific applications. In some cases, alternative attachment methods establishing magnetic systems or clip-on mechanisms may be developed to provide different installation options or to accommodate unique grille designs that may not be compatible with a stem-and-fin system.

In an aspect of the present disclosure is a vehicle accessory, comprising: a decorative portion having a flat back and a front face, the decorative portion as shown in FIG. 1A having a length 110 preferably between 5 cm and 15 cm but other sizes could be used depending on the application, a height 120 of 5 cm to 15 cm but other sizes could be used depending on the application and a thickness 230 of about 0.5 cm; and a stem connected to the flat back of the decorative portion, the stem having a length 260 as shown in FIG. 2 between 2 inches and 4 inches but other sizes could be used depending on the application and comprising a plurality of flexible fins decreasing in diameter from a base of the stem to a tip of the stem, wherein the vehicle accessory is configured to be inserted into and retained within openings of a vehicle grille.

In another aspect of the present disclosure is the vehicle accessory of the instant innovation, wherein the decorative portion is made of a material selected from the group consisting of Acrylonitrile Butadiene Styrene (ABS), Polyvinyl Chloride (PVC), nylon, Low-Density Polyethylene (LDPE), thermoplastic and silicone.

In another aspect of the present disclosure is the vehicle accessory of the instant innovation, wherein the stem comprises six flexible fins.

In another aspect of the present disclosure is the system of the instant innovation, wherein the flexible fins 220 as shown in FIG. 5 decrease in diameter 280 or length and height depending on the shape from about 2-5 inches at the base of the stem to about 0.25 inch at the tip diameter 270 of the stem.

In another aspect of the present disclosure is the vehicle accessory of the instant innovation, wherein the stem is made of a flexible, corrugated material.

In another aspect of the present disclosure is the vehicle accessory of the instant innovation, wherein the flexible, corrugated material is selected from the group consisting of Acrylonitrile Butadiene Styrene (ABS), nylon, Low-Density Polyethylene (LDPE), thermoplastics, Polyvinyl Chloride (PVC), and silicone.

In another aspect of the present disclosure is the vehicle accessory of the instant innovation, wherein the stem is connected to the flat back of the decorative portion using an adhesive, by placing pressure-sensitive adhesive sheets, and applying the stem to the flat back of the decorative portion.

In another aspect of the present disclosure is a method of customizing a vehicle appearance, comprising: providing a vehicle accessory having a decorative portion with a flat back and a front face, and a stem connected to the flat back of the decorative portion, the stem comprising a plurality of flexible fins decreasing in diameter or size from a base of the stem to a tip of the stem; and inserting the stem of the vehicle accessory into an opening of a vehicle grille such that the front face of the decorative portion is visible when viewing the vehicle grille. The method of the instant innovation, wherein the decorative portion has a length between 5 cm and 15 cm, a height between 5 cm and 15 cm, and a thickness of about 0.5 cm.

In another aspect of the present disclosure is the method of the instant innovation, wherein the decorative portion is made of a material selected from the group consisting of Acrylonitrile Butadiene Styrene (ABS), Polyvinyl Chloride (PVC), nylon, Low-Density Polyethylene (LDPE), thermoplastics and silicone.

In another aspect of the present disclosure is the method of the instant innovation, wherein the stem has a length between 2 inches and 6 inches.

In another aspect of the present disclosure is the method of the instant innovation, wherein the stem comprises six flexible fins.

In another aspect of the present disclosure is the system of the instant innovation, wherein the flexible fins 220 as shown in FIG. 5 decrease in diameter 280 from about 2-5 inches at the base of the stem to about 0.25 inch at the tip diameter 270 of the stem.

In another aspect of the present disclosure is the method of the instant innovation, further comprising removing the vehicle accessory from the opening of the vehicle grille and inserting a second vehicle accessory having a different decorative portion into the opening of the vehicle grille.

In another aspect of the present disclosure is a system for customizing vehicle appearance, comprising: a vehicle having a front grille with a plurality of openings; and a vehicle accessory comprising a decorative portion with a flat back and a front face, and a stem connected to the flat back of the decorative portion, the stem comprising a plurality of flexible fins decreasing in diameter from a base of the stem to a tip of the stem, wherein the stem is configured to be inserted into and retained within at least one of the plurality of openings in the front grille of the vehicle.

In another aspect of the present disclosure is the system of the instant innovation, wherein the decorative portion has a length between 5 cm and 15 cm, a height between 5 cm and 15 cm, and a width of about 0.5 cm.

In another aspect of the present disclosure is the system of the instant innovation, wherein the decorative portion is made of a material selected from the group consisting of Acrylonitrile Butadiene Styrene (ABS), Polyvinyl Chloride (PVC), nylon, Low-Density Polyethylene (LDPE), thermoplastic and silicone.

In another aspect of the present disclosure is the system of the instant innovation, wherein the stem has a length between 2 inches and 4 inches or 1 inches to 6 inches and comprises of a plurality of flexible fins preferably six flexible fins.

In another aspect of the present disclosure is the system of the instant innovation, wherein the flexible fins 220 as shown in FIG. 5 decrease in diameter 280 from about 2-5 inches at the base of the stem to about 0.25 inch at the tip diameter 270 of the stem. However, any suitable diameter is envisioned depending on the grille size of the intended vehicle.

In another aspect of the present disclosure is the system of the instant innovation, wherein the stem is made of a flexible, corrugated material selected from the group consisting of Acrylonitrile Butadiene Styrene (ABS), nylon, Low-Density Polyethylene (LDPE), thermoplastics and silicone, and is connected to the flat back of the decorative portion using an adhesive, by placing pressure-sensitive adhesive sheets, and applying the stem to the flat back of the decorative portion.

In another aspect of the present disclosure, an assembly of at least one of the aforementioned embodiments of components of the instant innovation into a kit makes installation simple and easy for a user because any parts necessary to connect the at least one embodiments of components of the instant innovation can be assembled to an at least one embodiment of at least one receiver or receptacle for the instant innovation, without necessitating special tools, sealants, adhesives, or other connection measures. The stem could be tapered to and the holes in the flexible fins could vary in size so that they fit appropriately on the tapered stem.

Referring now to the drawings FIG. 1A, FIG. 1B and FIGS. 2-5, and more particularly to FIG. 1A and FIG. 1 B, there is shown a sample front-facing decorative portion of embodiments of the instant innovation, according to aspects of the present disclosure. FIG. 2 depicts a side view of a stem component for embodiments of the instant innovation, according to an embodiment. FIG. 3 shows a side view of a corrugated stem component for embodiments of the instant innovation, according to aspects of the present disclosure. FIG. 4 illustrates a front orthogonal view of a vehicle grille with embodiments of the instant innovation installed, according to an embodiment.

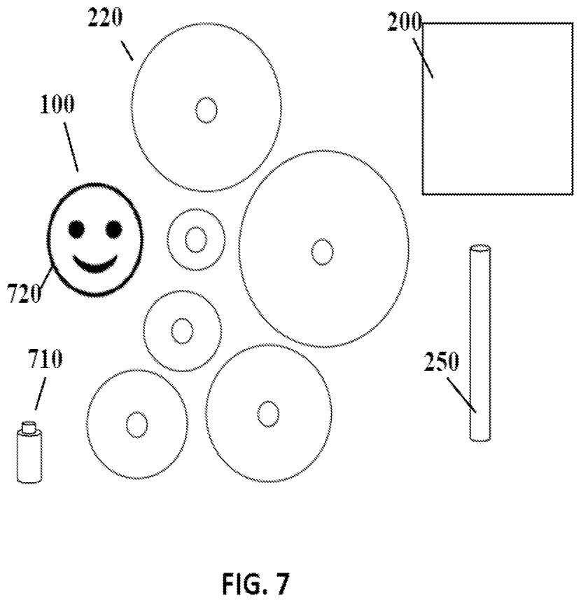

The assembly of all the items into a kit makes the installation simple and easy for the user because the parts necessary to assemble the vehicle accessory can be provided separately and assembled by the user prior to installation. The parts of the kit are shown in FIG. 7 and include the stem component 250, support 200, flexible fins 220 and decorative portion 100.

The instant innovation can be described as a vehicle accessory, comprising:
a. a decorative portion having a flat back and a front face, the decorative portion having a length between 5 cm and 15 cm, a height between 5 cm and 15 cm, and a width of approximately 0.5 cm; and
b. a stem connected to the flat back of the decorative portion, the stem having a length between 2 inches and 4 inches and comprising a plurality of flexible fins decreasing in diameter from a base of the stem to a tip of the stem,
c. wherein the vehicle accessory is configured to be inserted into and retained within openings of a vehicle grille.

The vehicle accessory of the instant innovation, wherein the decorative portion is made of a material selected from the group consisting of nylon, Low-Density Polyethylene (LDPE), thermoplastic, Acrylonitrile Butadiene Styrene (ABS), Polyvinyl Chloride (PVC), nylon, Low-Density Polyethylene (LDPE), thermoplastic and silicone.

The vehicle accessory of the instant innovation, wherein the stem comprises six flexible fins.

The vehicle accessory of the instant innovation, wherein the flexible fins decrease in diameter from approximately 2-3 inches at the base of the stem to approximately 0.25 inch at the tip of the stem.

The vehicle accessory of the instant innovation, wherein the stem is made of a flexible, corrugated material.

The vehicle accessory of the instant innovation, wherein the flexible, corrugated material is selected from the group consisting of Acrylonitrile Butadiene Styrene (ABS) and silicone.

The vehicle accessory of the instant innovation, wherein the stem is connected to the flat back of the decorative portion using an adhesive.

A method of customizing a vehicle appearance, comprising:
a. providing a vehicle accessory having a decorative portion with a flat back and a front face, and a stem connected to the flat back of the decorative portion, the stem comprising a plurality of flexible fins decreasing in diameter from a base of the stem to a tip of the stem; and
b. inserting the stem of the vehicle accessory into an opening of a vehicle grille such that the front face of the decorative portion is visible when viewing the vehicle grille.

The method of the instant innovation, wherein the decorative portion has a length between 5 cm and 15 cm, a height between 5 cm and 15 cm, and a width of approximately 0.5 cm.

The method of the instant innovation, wherein the decorative portion is made of a material selected from the group consisting of nylon, Low-Density Polyethylene (LDPE), thermoplastic, Acrylonitrile Butadiene Styrene (ABS), Polyvinyl Chloride (PVC), and silicone.

The method of the instant innovation, wherein the stem has a length between 2 inches and 4 inches.

The method of the instant innovation, wherein the stem comprises six flexible fins.

The method of the instant innovation, wherein the flexible fins decrease in diameter from approximately 2-3 inches at the base of the stem to approximately 0.25 inch at the tip of the stem.

The method of the instant innovation, further comprising removing the vehicle accessory from the opening of the vehicle grille and inserting a second vehicle accessory having a different decorative portion into the opening of the vehicle grille.

A kit for customizing vehicle appearance using a vehicle accessory comprising:
a. a decorative portion with a flat back having a front face,
b. a stem,
c. a support having a flat back, a plurality of flexible fins of decreasing in diameter and the flexible fins having a hole enabled to pass the stem through and the flexible fins are enabled to be attached to the stem.

Wherein the support is enabled to be attached to the stem and the plurality of flexible fins fit onto the stem such that the largest diameter flexible fin fits onto the stem proximal to the support and the smallest diameter flexible fin fits on the stem distal from the support and the stem is configured to be inserted into and retained within at least one of the plurality of openings in the front grille of the vehicle.

The system of the instant innovation, wherein the decorative portion has a length between 5 cm and 15 cm, a height between 5 cm and 15 cm, and a thickness of approximately 0.5 cm.

The system of the instant innovation, wherein the decorative portion is made of a material selected from the group consisting of Acrylonitrile Butadiene Styrene (ABS), Polyvinyl Chloride (PVC), nylon, Low-Density Polyethylene (LDPE), thermoplastic and silicone.

The system of the instant innovation, wherein the stem has a length between 2 inches and 4 inches and comprises six flexible fins.

The system of the instant innovation, wherein the flexible fins decrease in diameter from approximately 2-5 inches at the base of the stem to approximately 0.25 inch at the tip of the stem.

The system of the instant innovation, wherein the stem is made of a flexible, corrugated material selected from the group consisting of Acrylonitrile Butadiene Styrene (ABS), Polyvinyl Chloride (PVC), nylon, Low-Density Polyethylene (LDPE), thermoplastic and silicone, and is connected to the flat back of the decorative portion using an adhesive.

Referring now to the drawings FIGS. 1-7 , and more particularly to FIG. 1A and FIG. 1B, there is shown a front-facing decorative portions of the instant innovation, according to aspects of the present disclosure comprises of a decorative portion 100 with a length 110 and a height 120.

FIG. 2 depicts a side view of a stem component of the instant innovation, according to aspects of the present disclosure and shows stem component 250, support 200, flexible fins 220 and length 260 of stem component 250 and the thickness 230 of the support 200.

FIG. 3 shows a side view of a corrugated stem component of the instant innovation, according to aspects of the present disclosure and shows stem component 250, support 200, flexible fins 220.

FIG. 4 illustrates a front orthogonal view of a vehicle grille with decorative portion 100 of the instant innovation installed, according to aspects of the present disclosure.

FIG. 5 shows a top view of a corrugated stem component of the instant innovation, according to aspects of the present disclosure showing stem component 250, support 200, flexible fins 220 and stem tip diameter 270 and flexible fins 220 diameter 280.

FIG. 6 shows an alternative embodiment of the instant innovation with the flexible fins 220 installed at an angle 610 to the plane of the support 200. The angle 610 can be from 1-50 degrees but preferably 15 degrees.

FIG. 7 shows a kit of the components of the instant innovation showing the stem component 250, a support 200, a plurality of flexible fins 220 and a decorative portion 100.

The kit for customizing vehicle appearance comprising:
a. a decorative portion 100 with a back and front face;
b. a stem component 250;
c. a support 200 having a front face and the back face enabled to connect to the stem;
d. a plurality of flexible fins 220 of decreasing diameter and the flexible fins having a hole enabled to pass the stem through;
e. an adhesive 710 enabled to attach the stem to the back face of the support; and
f. an adhesive 720 located on the decorative portion back enabled to attach the decorative portion to the front face of the support.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present innovation has been described with reference to embodiments, it should be noted and understood that various modifications and variations can be crafted by those skilled in the art without departing from the scope and spirit of the innovation. Accordingly, the foregoing disclosure should be interpreted as illustrative only and is not to be interpreted in a limiting sense. Further it is intended that any other embodiments of the present innovation that result from any changes in application or method of use or operation, method of manufacture, shape, size, or materials which are not specified within the detailed written description or illustrations contained herein are considered within the scope of the present innovation.

Insofar as the description above and the accompanying drawings disclose any additional subject matter that is not within the scope of the claims below, the innovations are not dedicated to the public and the right to file one or more applications to claim such additional innovations is reserved.

Although very narrow claims are presented herein, it should be recognized that the scope of this innovation is much broader than presented by the claim. It is intended that broader claims will be submitted in an application that claims the benefit of priority from this application.

While this innovation has been described with respect to at least one embodiment, the present innovation can be further modified within the spirit and scope of this disclosure. This application is therefore intended to cover any variations, uses, or adaptations of the innovation using its general principles. Further, this application is intended to cover such departures from the present disclosure as come within known or customary practice in the art to which this innovation pertains and which fall within the limits of the appended claims.

A number of implementations have been described. Nevertheless, it will be understood that various modifications may be made without departing from the spirit and scope of the disclosure. Accordingly, other implementations are within the scope of the following claims.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A vehicle accessory, comprising:
a decorative portion having a flat back and a front face, the decorative portion having a length between 5 cm and 15 cm, a height between 5 cm and 15 cm, and a width of approximately 0.5 cm; and
a stem connected to the flat back of the decorative portion, the stem having a length between 2 inches and 4 inches and comprising a plurality of flexible fins decreasing in diameter from a base of the stem to a tip of the stem,
wherein the vehicle accessory is configured to be inserted into and retained within openings of a vehicle grille.

2. The vehicle accessory of claim 1, wherein the decorative portion is made of a material selected from the group consisting of Acrylonitrile Butadiene Styrene (ABS), Polyvinyl Chloride (PVC), and silicone.

3. The vehicle accessory of claim 1, wherein the stem comprises six flexible fins.

4. The vehicle accessory of claim 3, wherein the flexible fins decrease in diameter from approximately 2-3 inches at the base of the stem to approximately 0.25 inch at the tip of the stem.

5. The vehicle accessory of claim 1, wherein the stem is made of a flexible, corrugated material.

6. The vehicle accessory of claim 5, wherein the flexible, corrugated material is selected from the group consisting of Acrylonitrile Butadiene Styrene (ABS) and silicone.

7. The vehicle accessory of claim 1, wherein the stem is connected to the flat back of the decorative portion using an adhesive.

8. A method of customizing a vehicle appearance, comprising:
providing a vehicle accessory having a decorative portion with a flat back and a front face, and a stem connected to the flat back of the decorative portion, the stem comprising a plurality of flexible fins decreasing in diameter from a base of the stem to a tip of the stem; and
inserting the stem of the vehicle accessory into an opening of a vehicle grille such that the front face of the decorative portion is visible when viewing the vehicle grille.

9. The method of claim 8, wherein the decorative portion has a length between 5 cm and 15 cm, a height between 5 cm and 15 cm, and a width of approximately 0.5 cm.

10. The method of claim 9, wherein the decorative portion is made of a material selected from the group consisting of Acrylonitrile Butadiene Styrene (ABS), Polyvinyl Chloride (PVC), and silicone.

11. The method of claim 8, wherein the stem has a length between 2 inches and 4 inches.

12. The method of claim 11, wherein the stem comprises six flexible fins.

13. The method of claim 12, wherein the flexible fins decrease in diameter from approximately 2-3 inches at the base of the stem to approximately 0.25 inch at the tip of the stem.

14. The method of claim 8, further comprising removing the vehicle accessory from the opening of the vehicle grille and inserting a second vehicle accessory having a different decorative portion into the opening of the vehicle grille.

15. A kit for customizing vehicle appearance comprising
a decorative portion with a back and front face;
a stem;
a support having a front face and the back face enabled to connect to the stem;
a plurality of flexible fins of decreasing diameter and the flexible fins having a hole enabled to pass the stem through;
an adhesive enabled to attach the stem to the back face of the support; and
an adhesive located on the decorative portion back enabled to attach the decorative portion to the front face of the support.

16. The kit of the claim 15, wherein the decorative portion has a length between 5 cm and 15 cm, a height between 5 cm and 15 cm, and a width of approximately 0.5 cm.

17. The kit of claim 15, wherein the decorative portion is made of a material selected from the group consisting of Acrylonitrile Butadiene Styrene (ABS), Polyvinyl Chloride (PVC), nylon, Low-Density Polyethylene (LDPE), thermoplastic and silicone.

18. The kit of claim 15 wherein the stem has a length between 2 inches and 4 inches and comprises six flexible fins.

19. The kit of claim 15, wherein the flexible fins decrease in diameter from approximately 2-3 inches at the base of the stem to approximately 0.25 inch at the tip of the stem.

20. The kit of claim 15, wherein the stem is made of a flexible, corrugated material selected from the group consisting of Acrylonitrile Butadiene Styrene (ABS) and silicone, and is connected to the flat back of the decorative portion using an adhesive.
